(19) United States
(12) Patent Application Publication
(10) Pub. No.: US 2007/0070407 A1
(43) Pub. Date: Mar. 29, 2007

(54) Order processing apparatus and method, and image forming apparatus and method

(75) Inventors: Yousuke Katou, Kanagawa (JP); Makoto Kagaya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/519,151

(22) Filed: Sep. 12, 2006

(30) Foreign Application Priority Data
Sep. 29, 2005 (JP) 2005-285093

(51) Int. Cl. G06F 3/12

(52) U.S. Cl. 358/1.15

(57) ABSTRACT

In a printing system, an order processing apparatus processes an order for producing a print according to image data. There is an image reception unit for inputting raw image data that has been obtained by electronic image pickup and is unprocessed in relation to image processing. An image processor forms plural sample images adapted to observation of conditioned finish of printing by the image processing of the raw image data at plural different condition settings. The plural condition settings are determined by varying plural image processing conditions. The image processor forms a sample image group in an index form by arranging and combining the plural sample images. The plural sample images are arranged in an image array, and a parameter in relation to one of the plural image processing conditions varies stepwise in the image array.

### BACKGROUND OF THE INVENTION

1. Field of the Invention

The present invention relates to an order processing apparatus and method, and image forming apparatus and method. More particularly, the present invention relates to an order processing apparatus and method, in which preference of a customer for producing a print of a photograph can be designated and input easily, and image forming apparatus and method.

2. Description Related to the Prior Art

A digital still camera is equipment for acquiring image data to record an image. An image pickup device in the digital still camera, for example, CCD image sensor, CMOS image sensor or the like, outputs an image signal of an analog form, which is converted to digital data and stored in a data storage. A widely used format of image recordable to the data storage is the EXIF file, according to which the image signal is processed by image processing and compressed according to the JPEG format before storing. Also, raw image data of CCD-RAW file is known, which is unprocessed according to the image signal. JP-A 2002-330388 discloses the digital still camera in which the raw image data is recordable by photographing an image.

As the image pickup device can detect only brightness of the color, filters of red, green and blue colors are combined with the image pickup device. Color information of three primary colors of red, green and blue colors is obtained as the image signal. The combination of the color information is referred to as the raw image data. For the purpose of digital image processing, an image processor is incorporated in the digital still camera for subjecting the raw image data to image processing of plural types, for example color conversion, white balance conversion, exposure processing and the like. To use the EXIF format, the raw image data is processed by the image processing to obtain and store the processed image data.

There are parameters predetermined in the image processor incorporated in the digital still camera. Each of condition settings of image processing is defined by a combination of a plurality of the parameters. A problem lies a finished state of a processed image comes to have a narrowly conditioned appearance after the image processing of the image processor, because the finished state depends on the parameters. The finished state cannot be changed very much even when image correction processing is made for image data after the image processing. Some of numerous camera users wishes to finish an image according to his or her preference and differently from the image processing associated with the digital still camera. The use of the raw image data is supported by such users.

JP-A 2002-330388 discloses a printing system for producing a print according to the raw image data. For printing, the raw image data of one image frame is subjected to the image processing with a plurality of the parameters associated with the condition setting. Plural test images are displayed on a display panel in a reduced size with different parameters. Image frames are selected from the test images, to designate preferred ones of the parameters. The parameters are designated for respectively the condition settings, to facilitate acquisition of the finished state of images.

The parameters of the condition settings, for example exposure and white balance, are factors influencing to one another. The finished state of a developed image is determined according to a combination of a plurality of the parameters of the condition settings. However, only each one of the parameters is changed for simulating plural test images in relation to the condition settings. This is likely to cause separation of an obtained result of the finished state and an expected condition of the finished state in designating the parameters, as the finished state is difficult to estimate.

### SUMMARY OF THE INVENTION

In view of the foregoing problems, an object of the present invention is to provide an order processing apparatus and method, in which preference of a customer for producing a print of a photograph can be designated and input easily, and image forming apparatus and method.

In order to achieve the above and other objects and advantages of this invention, an order processing apparatus for processing an order for producing a print according to image data is provided. The order processing apparatus includes an image reception unit for inputting raw image data that has been obtained by electronic image pickup and is unprocessed in relation to image processing. An image processor forms plural sample images adapted to observation of conditioned finish of printing by the image processing of the raw image data at plural different condition settings, the plural condition settings being determined by varying plural image processing conditions. The image processor forms a sample image group in an index form by arranging and combining the plural sample images.

The plural sample images are arranged in an image array, and a parameter in relation to one of the plural image processing conditions varies stepwise in the image array.

Furthermore, a sample image memory stores image data of the plural sample images and image data of the sample image group. A parameter designating memory stores parameter designation information of the parameter associated with a selected one of the sample images by selectively designating the selected one among the sample images.

The plural image processing conditions are at least two selected from exposure information, white balance information and chromaticity information.

The white balance information is at least one of light source type information and color temperature information.

The image processor further processes for image forming of information of the condition setting for each of the sample images, the condition setting information being combined with the sample image group.

The image processor includes a format converter for converting a file format of the raw image data before image processing into a predetermined file format.

The plural sample images are arranged in a matrix two-dimensionally, and the exposure information changes along one of vertical and horizontal axes, and the white balance information changes along a remaining one of the vertical and horizontal axes.

Furthermore, there is a display panel for displaying the sample image group.

Furthermore, an image forming printer component prints an image sheet of the sample image group.

Also, an order processing method of processing an order for producing a print according to image data is provided. Raw image data that has been obtained by electronic image pickup and is unprocessed in relation to image processing is input. Plural sample images are formed, adapted to observation of conditioned finish of printing by the image processing of the raw image data at plural different condition settings, the plural condition settings being determined by varying plural image processing conditions, and also forming a sample image group in an index form by arranging and combining the plural sample images. A parameter associated with a selected one of the sample images is designated by selectively designating the selected one among the sample images.

An index image forming apparatus includes an image reception unit for inputting raw image data that has been obtained by electronic image pickup and is unprocessed in relation to image processing. An image processor forms plural sample images adapted to observation of conditioned finish of printing by the image processing of the raw image data at plural different condition settings, the plural condition settings being determined by varying plural image processing conditions. The image processor forms a sample image group in an index form by arranging and combining the plural sample images.

Furthermore, a display panel displays the sample image group. An image forming printer component prints an image sheet of the sample image group.

Also, an index image forming method includes steps of forming plural sample images adapted to observation of conditioned finish of printing by image processing of raw image data at plural different condition settings, the raw image data having been obtained by electronic image pickup and being unprocessed in relation to image processing, the plural condition settings being determined by varying plural image processing conditions. A sample image group is formed in an index form by arranging and combining the plural sample images.

In one aspect of the invention, an image sheet includes plural sample images adapted to observation of conditioned finish of printing by image processing of image data at plural different condition settings, the plural condition settings being determined by varying plural image processing conditions.

The plural sample images are arranged in an image array, and a parameter in relation to one of the plural image processing conditions varies stepwise in the image array.

The plural image processing conditions are at least two selected from exposure information, white balance information and chromaticity information.

Furthermore, information of the condition setting is expressed by image forming for each of the sample images, combined with the sample image group.

The image data is used after converting a file format of the raw image data before image processing into a predetermined file format.

The plural sample images are arranged in a matrix two-dimensionally, and the exposure information changes along one of vertical and horizontal axes, and the white balance information changes along a remaining one of the vertical and horizontal axes.

Also, a computer executable order processing program for processing an order for producing a print according to image data is provided. An image reception program code is for inputting raw image data that has been obtained by electronic image pickup and is unprocessed in relation to image processing. An image processing program code is for forming plural sample images adapted to observation of conditioned finish of printing by the image processing of the raw image data at plural different condition settings, the plural condition settings being determined by varying plural image processing conditions. An image forming program code is for forming a sample image group in an index form by arranging and combining the plural sample images.

The plural sample images are arranged in an image array, and a parameter in relation to one of the plural image processing conditions varies stepwise in the image array.

Furthermore, an image writing program code is for writing image data of the plural sample images and image data of the sample image group. A parameter designating program code is for writing parameter designation information of a parameter associated with a selected one of the sample images by selectively designating the selected one among the sample images.

Also, an order processing user interface for processing an order for producing a print according to image data is provided. An image reception region is for inputting raw image data that has been obtained by electronic image pickup and is unprocessed in relation to image processing. An image processing region is for forming plural sample images adapted to observation of conditioned finish of printing by the image processing of the raw image data at plural different condition settings, the plural condition settings being determined by varying plural image processing conditions. An image forming region is for forming a sample image group in an index form by arranging and combining the plural sample images.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating an order processing apparatus;

FIG. 2 is an explanatory view in plan, illustrating an image sheet with a sample image group;

FIG. 3 is a flow chart illustrating steps of order processing;

FIG. 4 is an explanatory view in plan, illustrating another preferred image sheet in which color temperature is used as a image processing condition;

FIG. 5 is an explanatory view in plan, illustrating one preferred image sheet in which chromaticity is used as a image processing condition;

FIG. 6 is a block diagram illustrating an order processing system in connection with the Internet.

### DETAILED DESCRIPTION OF THE PREFERRED EMBODIMENT(S) OF THE PRESENT INVENTION

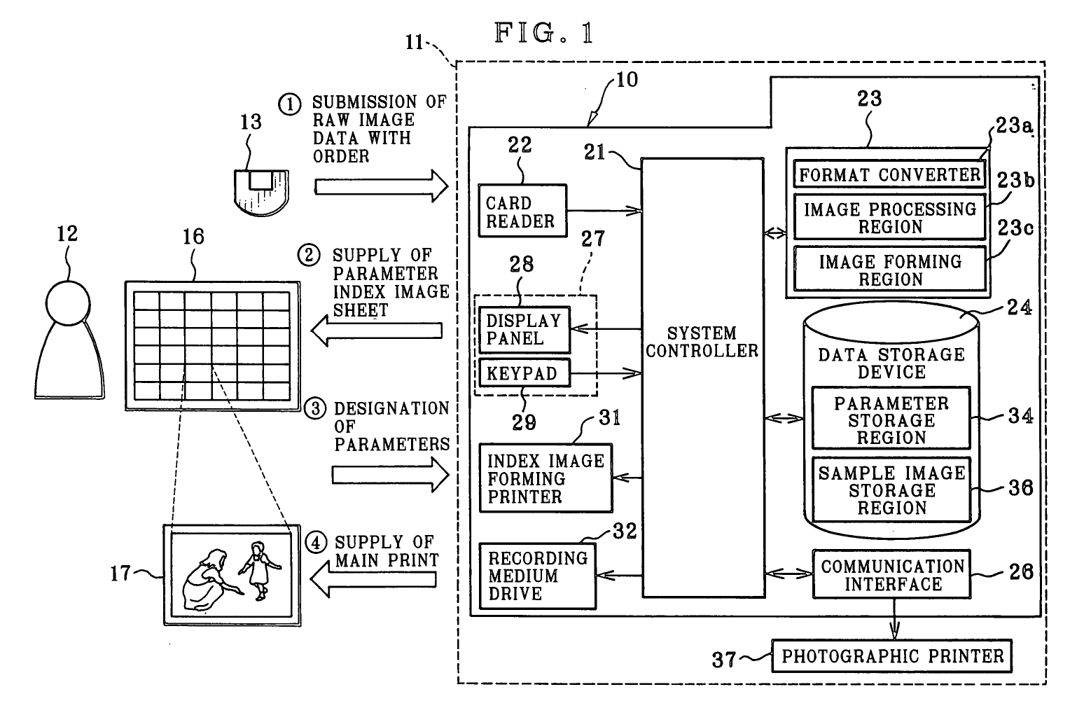

In FIG. 1, an order processing apparatus 10 processes an order for printing of image frames according to image data obtained by electronic image pickup. For example, the image frames have been originally created by an electronic camera. A photo shop 11 has the order processing apparatus 10 which is installed and manually operated by a photo finisher, attendant, operator, or other user. A memory card 13 with raw image data is used as a storage for storing image data. A customer 12 brings or forwards the memory card 13 to the photo shop 11. There are plural file formats of image data which the order processing apparatus 10 can process, for example EXIF file and RAW file, which is referred to as raw image data.

A parameter index image print, or sample or test image sheet 16 with a test image group is produced by the order processing apparatus 10 when an order for printing is placed with inputs of raw image data. The parameter index image sheet 16 will be supplied to the customer 12. A purpose of the parameter index image sheet 16 is for the customer 12 easily to determine parameters of the digital development to which the raw image data is subjected. Plural test images of a thumbnail shape are arranged in one frame of a test image group in various condition settings of plural parameters. As a print sheet with the test image group, the parameter index image sheet 16 is formed, which is also referred to as a round print. The plural test images are based on only one original image, but are different in the finished state, and are candidate images of which the customer 12 can screen one best condition setting suitable for his or her preference in the finished state. The selected condition setting is designated for a photo finisher to input the designated values of the parameters. One frame with an image of the raw image data is printed on photographic paper at the designated parameter. A main print 17 is obtained and supplied to the customer 12.

The order processing apparatus 10 has a system controller 21, a card reader 22 as interface or image reception device, an image processor 23, a data storage device 24, a communication interface 26, a user interface or console panel 27, an index image forming printer 31, and a recording medium drive 32. The user interface 27 includes a display panel 28 and a keypad 29. The system controller 21 includes a CPU, ROM, RAM and the like, and controls elements in the order processing apparatus 10 in response to input signals from the order processing apparatus 10. The keypad 29 or a keyboard together with a mouse is an input device for entry of command signals to the system controller 21. The display panel 28 displays an operating menu, input images and other indicia or message information. Note that the user interface 27 may be a touch panel type of display panel which includes the display panel 28 and the keypad 29. The card reader 22 accesses the memory card 13 and reads image data of any one of various formats, for example EXIF and CCD-RAW formats.

The image processor 23 creates a test image group according to input raw image data. The image processor 23 includes a format converter 23a, an image processing region 23b for digital image development, and an image forming region 23c. Raw image data are according to a plural number of file formats because of inequality between camera manufacturers in the file format, which is unlike the EXIF format as a publicly single format. The format converter 23a converts the raw image data of any one of the file formats into a predetermined file format, and transmits the converted image data to the image processing region 23b. The use of the format converter 23a is effective in no need in changing the image processing region 23b particularly when the known file formats are changed or when a new file format is added.

The image processing region 23b subjects raw image data of an image frame to digital development according to plural condition settings, and produces sample images or test images for checking a finished state of the development. Condition settings are combinations of conditions, which are white balance information, exposure information, and other information related to image processing. The image processor 23 changes a parameter stepwise for each of the conditions, to subject raw image data to development in plural condition settings. Test images are thus created. Data of the test images are transmitted to the image forming region 23c. The image forming region 23c processes the test image data by resizing, and produces data of test images of a reduced image size. Test images in the reduced size are arranged in one frame, to produce a test image group in an index form.

An example of the data storage device 24 is a hard disk drive, and stores an operating system (OS) and plural programs, and also stores image data acquired by use of the card reader 22. Also, the data storage device 24 has a parameter memory region 34 with a parameter designating memory, and a test image memory region 36. The parameter memory region 34 stores parameter data to which the image processor 23 refers. The test image memory region 36 stores test images before being processed for resizing.

The index image forming printer 31 produces the parameter index image sheet 16 by use of a recording sheet according to image data of the test image group produced by the image processor 23. Any one of known image forming device may be used as the index image forming printer 31, for example an ink jet printer for ejecting ink to print an image on a sheet, a laser printer in which laser light is applied to a photosensitive drum to form an image electrostatically, and toner is transferred to a recording sheet from the photosensitive drum. A size of the parameter index image sheet 16 may be any available size, for example an L size used widely in the field of photograph, or A4 size with a large area.

A photographic printer 37 to produce the main print 17 is connected by the communication interface 26 with the order processing apparatus 10. Image data of image frames to be designated for printing are transmitted by the communication interface 26 to the photographic printer 37. Laser light is applied in the photographic printer 37 to the photographic paper according to the image data. An image is created in a latent image form, and then photographically developed to acquire a photographic print.

Image data is transmitted to the photographic printer 37 in a form processed digitally according to the condition setting designated by the customer 12. In the known techniques, most of the available printers are not adapted to image files of the RAW format. It has been slightly difficult to process an order for printing according to image files of the RAW format. In the present invention, the order processing apparatus 10 is operable for digital development, and transmits image data to the photographic printer 37. This makes it possible to utilize the photographic printer 37 of general use without further modification.

The image data for transmission to the photographic printer 37 is sample image data or test image data produced in the course of producing the index test image group and stored in the test image memory region 36. The test image data in the test image memory region 36 is after the digital development but is unprocessed in relation to processing of resizing. The use of the test image data eliminates necessity of the digital development, so that the total time for producing the main print 17 can be shortened. Also, it is possible to preserve the test image data for a predetermined period, so the test image data can be reused if an order for reprinting is placed. This is effective in raising the speed of operation in reprinting.

The recording medium drive 32 writes image data to a CD (compact disk) or other recording medium. The photo shop 11 commercially writes image data to a recording medium as well as it supplies prints. The recording medium drive 32 is used in the photo shop 11, to produce a photo CD storing various data which a customer wishes to preserve in an edited form.

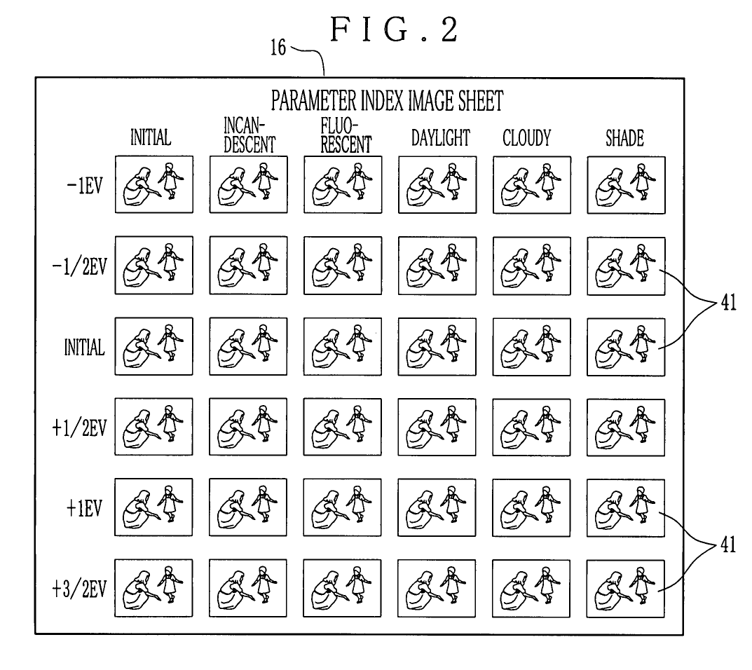

In FIG. 2, an example of the parameter index image sheet 16 is illustrated. Plural sample images or test images 41 are arranged in the parameter index image sheet 16 with reference to exposure information and white balance information in adjustment. A condition setting as an example is constituted by adjustable parameters of exposure information and white balance information. The test images 41 are 36 images arranged in a 6×6 matrix. A vertical axis is taken for a parameter of the exposure. A horizontal axis is taken for white balance information that is type information of light sources.

A step between values of the exposure parameter is ½ EV in both of the positive and negative directions and with reference to a value of an original state. Types of the light source type information include a light source used originally at the time of photographing, and also incandescent light, fluorescent light, daylight, light in a cloudy weather, and light in shade. Positions in the arrangement of test images are virtually stepwise and in the manner of color temperature values different from one another. Information of the condition setting or image processing conditions is indicated near to the test images 41 alphanumerically, for example, +½ EV, −1 EV, INCANDESCENT, and FLUORESCENT.

Parameters of the two conditions are arranged two-dimensionally. The test images 41 are arranged vertically and horizontally on the table of the changeable values of parameters, so as to list the estimated finished states of the image. This makes it possible to check finished images in a reliable manner as compared with the known technique in which a single parameter is changed for listing. Very slight difference will occur between the estimated finished state and the actually finished state as a result.

For a preferred finished state, the customer 12 selects a preferred one of the sample images or test images 41 within the parameter index image sheet 16, and notifies an operator of the selected one of preference. The display panel 28 of the user interface 27 displays an image equal to the test image group on the parameter index image sheet 16. The operator views a test image selected by the customer 12 on the display panel 28, and designates the same, to input the condition setting to the order processing apparatus 10 with the parameters of preference.

In the present embodiment, a step of values of the exposure parameter is ½ EV. However, a step of values of the exposure parameter may be ⅓ EV or the like. Also, the number of the types according to the light source type information may be more than or less than five (5). For example, flash light as a type of the light source type information may be added. A step between values of a parameter, the number of types of type information, and the like, can be predetermined, but also can be changed according to a setting input by the user interface 27.

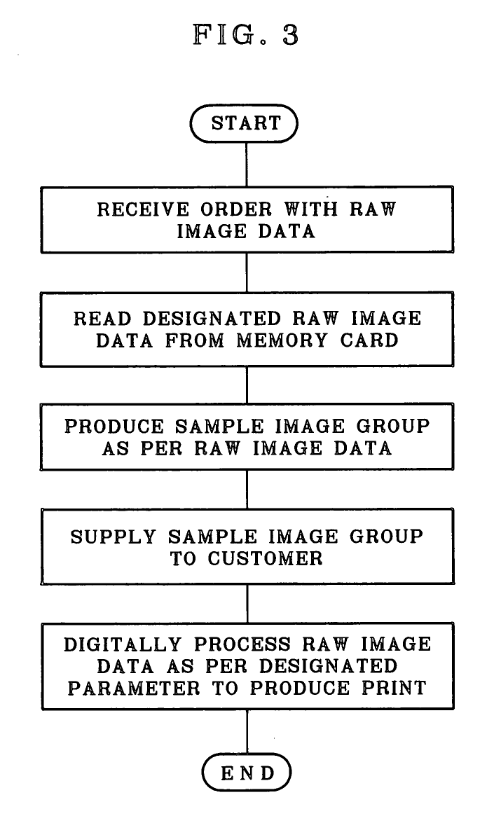

The operation of the above construction is described by referring to FIG. 3. An order for printing of images of raw image data of a format of CCD-RAW is processed. At first, an operator sets the memory card 13 from the customer 12 on the card reader 22, reads the raw image data for inputting to the order processing apparatus 10. The order processing apparatus 10 creates data of a test image group according to the raw image data, and causes the index image forming printer 31 to produce the parameter index image sheet 16.

The parameter index image sheet 16 is supplied to the customer 12. The customer 12 observes the parameter index image sheet 16, and if he or she finds one of the sample images or test images 41 acceptable for finishing, selects the same to designate the condition setting. If he or she does not find any one of the test images 41 acceptable for finishing, the parameter index image sheet 16 of a second time is produced by varying a set of parameters, and is supplied to the customer 12. The production of the parameter index image sheet 16 is repeated until at least one of the test images 41 is found acceptable. When the condition setting is designated, image data after the digital development according to the determined set of parameters are transmitted to the photographic printer 37, where the main print 17 is produced and supplied to the customer 12.

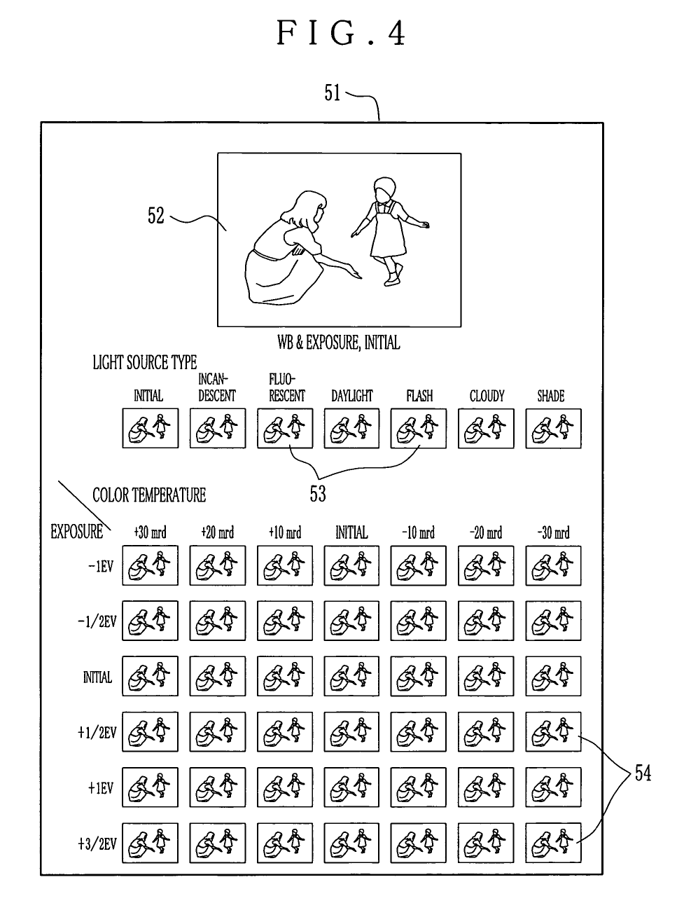

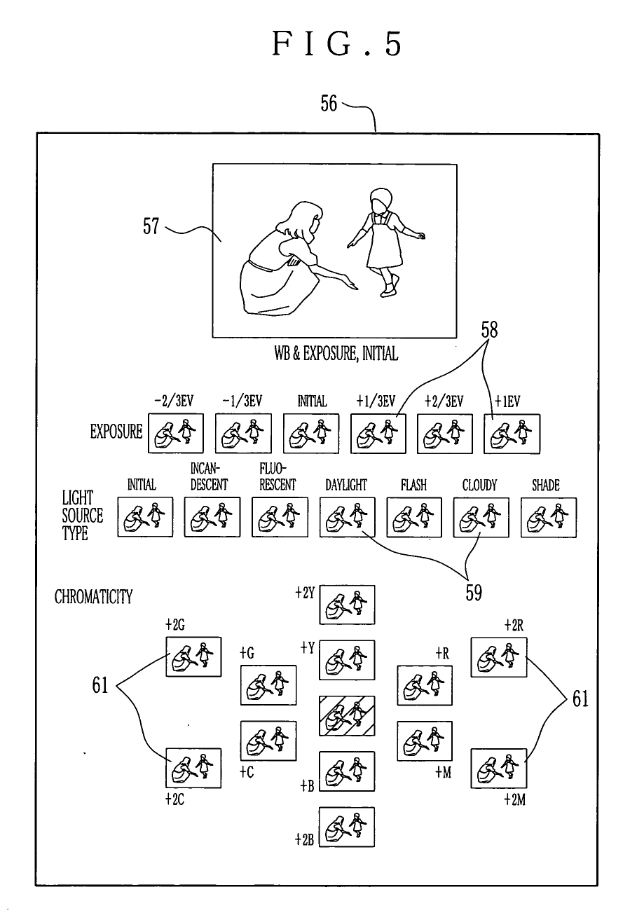

In FIGS. 4 and 5, another preferred parameter index image print or test image sheet 51 with a test image group is illustrated. In FIG. 4, a test image 52 is disposed in an upper portion of the parameter index image sheet 51 in an unprocessed original form with the white balance information and exposure information unchanged at the photographing time. The test image 52 has a larger size than remaining test images.

Plural test images 53 are arranged under the test image 52, and are formed according to variations of light source type information. 42 test images 54 are arranged under the test images 53 in a 6×7 matrix form. A vertical axis is taken for a parameter of the exposure. A horizontal axis is taken for white balance information that is a parameter of color temperature. A step between values of the color temperature parameter is 10 mired (mrd) in both of the positive and negative directions.

In FIG. 5, one preferred parameter index image print, or sample or test image sheet 56 with a test image group is illustrated. In condition settings, chromaticity information is additionally used with the exposure information and white balance information. A test image 57 is disposed in an upper portion of the parameter index image sheet 56 in an unprocessed original form with the white balance information and exposure information unchanged at the photographing time. Under this are disposed test images 58 of which the exposure parameter is changed stepwise in a horizontal direction. Under those, test images 59 are disposed of which the light source type information is changed for the plural types. Under those, test images 61 are disposed of which the chromaticity parameter is changed stepwise and in a two-dimensionally in a hue circle.

In the hexagonal form in the hue circle, an original point is defined with an original test image of the hatched portion in the setting at the time of photographing. Parameters of adjusting the chromaticity or color balance are arranged for yellow in the upward direction, for blue in the downward direction as a complimentary color of the yellow. The more distant a point is from the original point, the higher the density of the yellow or blue is. The green color is disposed diagonally from the magenta color as a complementary color. The red color is disposed diagonally from the cyan color as a complementary color. The parameters are changed stepwise according to the distance from the original point.

Condition settings, image processing conditions, the values and step of parameters, parameter types and the like can be modified. Also, arrangement of sample images or test images can be changed as desired. Furthermore, two or more test image sheets different from one another in the form may be supplied to a customer, who can designate by use of those test image sheets containing more information for consideration.

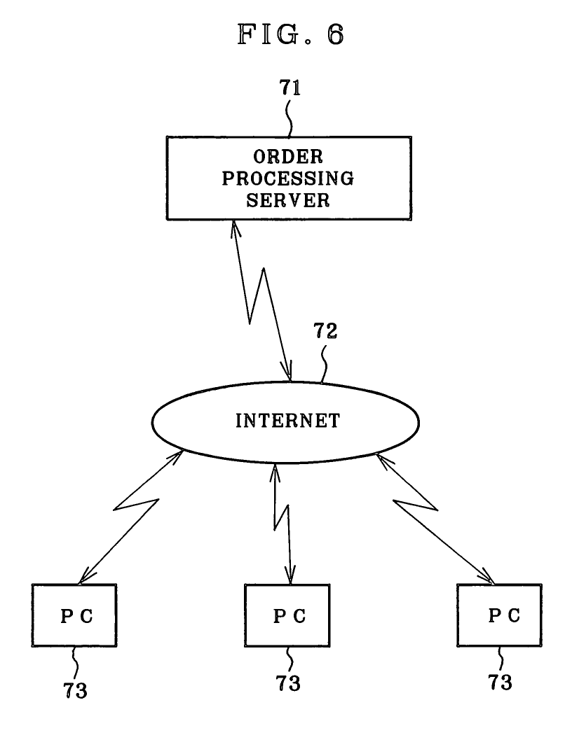

In the above embodiments, the order processing apparatus 10 is installed in a shop, store or other space where a user can directly operate the order processing apparatus 10. However, an order processing apparatus of the invention may be an order processing server 71 of FIG. 6. The Internet 72 is connected with the order processing server 71. Any one of personal computers 73 or nodes are connected with the Internet 72, and can be used to access the order processing server 71 by communication to place an order for printing.

To this end, there is a commercial web site accessible through the Internet 72 for processing orders. The customer operates the personal computer 73 to access the web site to place an order by transmission. There are an image processor and a data storage device in the order processing server 71 in manner similar to the order processing apparatus 10. When the order processing server 71 receives transmission of a set of raw image data uploaded by the personal computer 73 of the customer, the order is received. For processing, a sample image group or test image group is produced according to the raw image data. Then data of the test image group is transmitted to the personal computer 73 by communication of the Internet 72. The customer views the test image group on the display at the personal computer 73, and designates a condition setting by selecting one test image. The data of the condition setting is transmitted to the order processing server 71 to complete processing of an order for printing. After this, image data processed according to the condition setting is transmitted to a photographic printer to produce the main print 17. The main print 17 can be forwarded to or supplied to the customer.

In the above embodiment, the order processing apparatus 10 is for image forming of the test image group. However, an apparatus of the invention may be an image forming apparatus specialized for image forming of the test image group without order processing of an order for printing. Also, a component for the image forming according to the invention may be an electrophotographic device as well as a printer. Also, image forming of the invention may be according to a computer program in which data of a test image group is output but not subjected to printing. Order processing of an order for printing in the invention may be according to a computer program.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An order processing apparatus for processing an order for producing a print according to image data, comprising:
an image reception unit for inputting raw image data that has been obtained by electronic image pickup and is unprocessed in relation to image processing;
an image processor for forming plural sample images adapted to observation of conditioned finish of printing by said image processing of said raw image data at plural different condition settings, said plural condition settings being determined by varying plural image processing conditions;
said image processor forming a sample image group in an index form by arranging and combining said plural sample images.

2. An order processing apparatus as defined in claim 1, wherein said plural sample images are arranged in an image array, and a parameter in relation to one of said plural image processing conditions varies stepwise in said image array.

3. An order processing apparatus as defined in claim 2, further comprising:
a sample image memory for storing image data of said plural sample images and image data of said sample image group; and
a parameter designating memory for storing parameter designation information of said parameter associated with at least a selected one of said sample images.

4. An order processing apparatus as defined in claim 3, wherein said plural image processing conditions are at least two selected from exposure information, white balance information and chromaticity information.

5. An order processing apparatus as defined in claim 4, wherein said white balance information is at least one of light source type information and color temperature information.

6. An order processing apparatus as defined in claim 4, wherein said image processor further processes information of said condition setting for each of said sample images, said condition setting information being combined with said sample image group.

7. An order processing apparatus as defined in claim 4, wherein said image processor includes a format converter for converting a file format of said raw image data before image processing into a predetermined file format.

8. An order processing apparatus as defined in claim 4, wherein said plural sample images are arranged in a matrix two-dimensionally, and said exposure information changes along one of vertical and horizontal axes, and said white balance information changes along a remaining one of said vertical and horizontal axes.

9. An order processing apparatus as defined in claim 1, further comprising a display panel for displaying said sample image group.

10. An order processing apparatus as defined in claim 9, further comprising an image forming printer component for printing an image sheet of said sample image group.

11. An order processing method of processing an order for producing a print according to image data, comprising steps of:
inputting raw image data that has been obtained by electronic image pickup and is unprocessed in relation to image processing;
forming plural sample images adapted to observation of conditioned finish of printing by said image processing of said raw image data at plural different condition settings, said plural condition settings being determined by varying plural image processing conditions, and also forming a sample image group in an index form by arranging and combining said plural sample images; and
designating a parameter associated with a selected one of said sample images by selectively designating said selected one among said sample images.

12. An order processing method as defined in claim 11, wherein said plural sample images are arranged in an image array, and a parameter in relation to one of said plural image processing conditions varies stepwise in said image array.

13. An order processing method as defined in claim 12, wherein said plural image processing conditions are at least two selected from exposure information, white balance information and chromaticity information.

14. An index image forming apparatus comprising:
an image reception unit for inputting raw image data that has been obtained by electronic image pickup and is unprocessed in relation to image processing;
an image processor for forming plural sample images adapted to observation of conditioned finish of printing by said image processing of said raw image data at plural different condition settings, said plural condition settings being determined by varying plural image processing conditions;
said image processor forming a sample image group in an index form by arranging and combining said plural sample images.

15. An image forming apparatus as defined in claim 14, wherein said plural sample images are arranged in an image array, and a parameter in relation to one of said plural image processing conditions varies stepwise in said image array.

16. An image forming apparatus as defined in claim 15, wherein said plural image processing conditions are at least two selected from exposure information, white balance information and chromaticity information.

17. An image forming apparatus as defined in claim 14, further comprising:
a display panel for displaying said sample image group; and
an image forming printer component for printing an image sheet of said sample image group.

18. An index image forming method comprising steps of:
forming plural sample images adapted to observation of conditioned finish of printing by said image processing of raw image data at plural different condition settings, said raw image data having been obtained by electronic image pickup and being unprocessed in relation to image processing, said plural condition settings being determined by varying plural image processing conditions;
forming a sample image group in an index form by arranging and combining said plural sample images.
